(19) United States
(12) Patent Application Publication
(10) Pub. No.: US 2019/0047911 A1
(43) Pub. Date: Feb. 14, 2019

(54) Plant for production of cement with reduced emission of pollutant gasses

(71) Applicant: KHD Humboldt Wedag GmbH, Koeln (DE)

(72) Inventor: Heiko Schuermann, Leverkusen (DE)

(21) Appl. No.: 15/566,856

(22) PCT Filed: Apr. 12, 2016
(86) PCT No.: PCT/EP2016/057958

§ 371 Date: Oct. 16, 2017

(30) Foreign Application Priority Data
Apr. 14, 2015 (DE) 10 2015 004 577.6

(51) Int. Cl. C04B 7/36; C04B 7/44; C04B 7/43; F27B 7/20; F27D 17/00; F27B 7/36

(52) U.S. Cl. CPC C04B 7/365; C04B 7/367; C04B 7/4446; C04B 7/434; F27D 2017/009; F27D 17/001; F27D 17/004; F27B 7/36; F27B 7/2041

(57) ABSTRACT

A plant for production of cement clinker from raw meal, having a calciner for deacidification of the raw meal and a rotary furnace for sintering the deacidified raw meal to give cement clinker. The deacidified raw meal flows through a cyclone preheating stage into the rotary furnace. A reactor is provided upstream of the calciner on the flow path of the rotary furnace offgas to the calciner, to which an inlet for the rotary furnace offgas leads. A corresponding method of operating such a plant wherein fuel is added to the reactor in a superstoichiometric amount in relation to the residence time of the offgases in the reactor, such that carbon dioxide present in the offgases is reduced to carbon monoxide. At least one input air conduit for supplying input air, preferably coming from a tertiary air conduit, is provided at at least one point in the reactor.

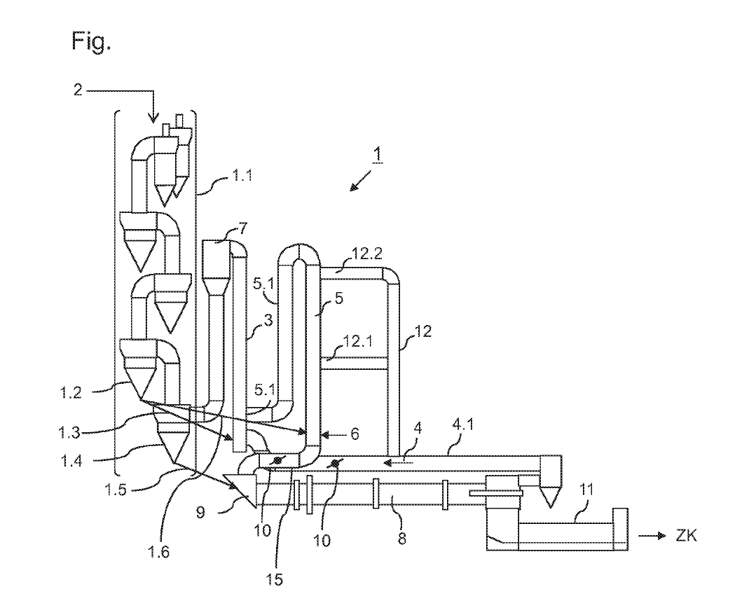

### CROSS-REFERENCES TO RELATED APPLICATIONS

This application claims the benefit of the German patent application No. 10 2015 004 577.6 filed on Apr. 14, 2015, the entire disclosures of which are incorporated herein by way of reference.

### BACKGROUND OF THE INVENTION

The invention relates to a plant for the production of cement clinker from raw meal comprising, seen in the direction of material flow, at least one calciner for deacidification of the raw meal and at least one rotary furnace for sintering of the deacidified raw meal into cement clinker, wherein the deacidified raw meal, after passing through the calciner, flows through a cyclone preheating stage into a rotary furnace, and wherein a reactor installed upstream of the calciner on the flow path of the offgas from the rotary furnace to the calciner is provided, to which an inlet for the offgas of the rotary furnace leads, and the invention further relates to a method corresponding to the operation of the plant for the production of cement clinker from raw meal comprising, seen in the direction of material flow, at least one calciner for deacidification of the raw meal, and at least one rotary furnace for sintering of the deacidified raw meal into cement clinker, wherein the deacidified raw meal, after passing through the calciner, flows through a cyclone preheating stage into a rotary furnace, thus conducting the offgases of the rotary furnace to a reactor installed upstream of the calciner on the flow path of the offgases from the rotary furnace to the calciner, wherein fuel is added to the reactor in a superstoichiometric amount in relation to the residence time of the offgases in the reactor such that carbon dioxide contained in the offgases (CO2) is reduced to carbon monoxide (CO).

In order to produce cement clinker, a mixture of calcareous and siliceous stone is ground and subjected to heat treatment, causing the carbon dioxide (CO2) to be formally removed from the lime, which is thus converted to burnt lime (CaO). In a further step, the raw meal deacidified by removal of CO2, which is composed of the originally non-deacidified calcareous stone and the as-yet unchanged siliceous stone, is sintered under heat into various calcium silicate phases.

The deacidification and the sintering of raw meal are endothermic processes that require heat to be carried out. This heat energy can be obtained from high-quality fuels. In addition to the classical primary fuels, such as coal, alternative fuels are increasingly being used as energy sources in cement plants for cost reasons, with these energy sources often being obtained from municipal or industrial waste.

The type of thermal treatment mentioned above makes it necessary to carry out the sintering in a rotary furnace, wherein the rotary furnace must be at extremely high temperatures of at least 1,450° C. for successful sintering of the calcium silicate phase. In order to generate these high temperatures in the rotary furnace, one must rely on flame temperatures that can be as high as 1,800° C. At this high temperature, both nitrogen present in the fuel, mostly in the form of amines, and atmospheric nitrogen present in the combustion air are burned to form nitrogen oxides (NOx). Unless measures are taken to prevent or reduce the resulting nitrogen oxides, they escape with the exhaust air of the rotary furnace into the open atmosphere, where they are converted by hydrolysis with atmospheric humidity to nitric acid (HNO3), nitrous oxide (HNO2), and other acidically reacting nitrogen oxide hydrates. The nitrogen oxides (NOX) that react acidically with atmospheric humidity are the cause of harmful acid rain, which reduces the natural pH of forest soils and weakens their resistance to disease. Various measures are known for reducing emissions of nitrogen oxides (NOX) from plants for the production of cement.

German Unexamined Patent Application DE 102013006237 A1 discloses a plant and a method wherein offgases of the rotary furnace of a plant for the production of cement are conducted to a reactor installed downstream of the rotary furnace that is arranged between the rotary furnace and a calciner, and fuel is added to the reactor (8). In this case, the fuel is added in a superstoichiometric amount in relation to the residence time of the offgases in the reactor such that carbon dioxide contained in the offgases is reduced to carbon monoxide (CO). The carbon monoxide (CO) serves as a reducing agent for nitrogen oxides (NOX), which are chemically reduced in a calciner despite the brief residence time.

German Unexamined Patent Application DE 102013006236 A1 discloses another plant for the production of cement clinker comprising, seen in the direction of material flow, at least one heat exchanger for preheating raw meal, at least one subsequent calciner for calcining of the raw meal, at least one rotary furnace for sintering of the calcined raw meal, and at least one clinker cooler for cooling of the sintered cement clinker, wherein a combustion device is provided for so-called difficult fuels showing unpredictable, or at least unstable, ignition and burnoff behavior, and the device carbonizes, pyrolyzes, and/or burns the difficult fuels, optionally in the presence of raw meal. According to the invention taught in the application, it is provided that the combustion device is configured as an upstream pot reactor or gooseneck reactor in an inverted U-shape, the outlet (5.2) of which opens into the calciner above a tertiary air line of the clinker cooler. This allows combustion of fuel that is lumpy and/or poorly ignitable, wherein the burnoff gases from incomplete combustion in the reactor are present in gaseous form in the calciner for further combustion.

In both methods, the oxygen required for fuel gasification, i.e., required for the pyrolysis of fuel to carbon monoxide (CO), originates on the one hand from the furnace inlet chamber (residual oxygen from the furnace combustion process) and also indirectly from the carbon dioxide CO2 present via a Boudouard reaction of the C in the fuel (CO2 reduction) to CO taking place in the pyrolysis chamber. In this case, the oxygen supply is a fixed constant, and this gives rise to the possibility of influencing the gasification process with respect to the temperature and gasification rate.

### SUMMARY OF THE INVENTION

An object of the invention is therefore to improve the control of gasification of the fuel.

This object of the invention is achieved in carrying out a method for operation of a plant for the production of cement by feeding fresh air into the reactor at at least one site in the reactor, wherein the fresh air preferably comes from a tertiary air line that feeds the recuperation air from a clinker cooler installed downstream of a rotary furnace in the direction of material flow back into the plant.

Accordingly, a plant for the production of cement is proposed in which at least one inlet air line of fresh air is provided at at least one site in the reactor.

It is therefore provided according to the invention that an additional reactor, compared to conventional plants for the production of cement, is installed upstream between the rotary furnace and the calciner, in which carbon monoxide (CO) is produced by the superstoichiometric addition of fuels. The carbon monoxide (CO) produced by the gasification and/or pyrolysis of sometimes difficult fuels with unpredictable ignition and burnoff behavior, as well as the carbon monoxide (CO) produced in a Boudouard reaction by the reduction of carbon dioxide (CO2) from the offgases of the rotary furnace is used in further process control as a gaseous reducing agent for the reduction of NOx, wherein free nitrogen (N2) and carbon dioxide (CO2) are again produced.

In this case, compared to the methods known from the applications DE 102013006236 A1 and DE 102013006237 A1, there is an additional fresh air feed, preferably from a tertiary air line present for heat recuperation. The preheated tertiary air carries considerable heat energy in order to reliably gasify or even pyrolyze the difficult fuels, wherein gasification and pyrolysis take place as an endothermic process. The decrease in temperature occurring in the endothermic process control is compensated for by combustion that is substoichiometric with respect to the fuel and superstoichiometric with respect to the combustion air or oxygen present, the combustion taking place as an exothermic process. In the ideal case, the process control is carried out by regulation of the fresh air supply. In autothermic process control, by means of exothermic process steps, exactly as much combustion or process heat is produced as that consumed by endothermic process steps that also occur during the process.

In order to regulate the process control, at least one control loop is provided in which a control device regulates the fresh air fed to the reactor based on one or a plurality of the parameters listed in the following: average reactor temperature, reactor temperature in the lower area of the reactor, reactor temperature in the upper area of the reactor, NOx emission, and gasification rate, measured as CO concentration. The temperature can be measured in a lower area of the reactor in which an endothermic process control takes place, and additionally in an upper area in which an exothermic process control takes place. Taking into account the amounts of gas produced during process control and their specific heat capacities, the fresh air can be regulated such that the process control takes place autothermically, i.e., exactly as much heat energy is consumed by gasification as is regenerated in the exothermic process control, which is optionally supported by fresh air or oxygen supply. The intent and purpose of autothermic process control is to supply as little fresh air or oxygen-enriched air or even pure oxygen (O2) as possible without withdrawing the heat necessary for the production of cement clinker. The goal of the invention is not to add more heat to the process by means of an additional combustion site between the rotary furnace and the calciner, but to first achieve the highest concentration of carbon monoxide (CO) under the best possible gasification of the difficult fuels so that undesirable nitrogen oxides (NOx) are reduced by the high carbon monoxide (CO) concentration. The carbon monoxide (CO) present in a superstoichiometric amount is significantly easier to oxidize in later process stages because of its increased reactivity.

The reactor installed between the rotary furnace and the calciner makes it possible to selectively influence the process parameters, such as the stoichiometry of the fuel and oxygen (O2) or air, but also the temperature and flow rate and thus the residence time of the fuels under the corresponding conditions. The reactor can be correspondingly configured to control the flow rate. In order to control the temperature, it is provided that water vapor and/or water (H2O) is/are injected into the reaction chamber. However, the decrease in temperature that is actually caused by accompanying heat loss and thus energy loss is necessary in order to maintain the conditions for a Boudouard reaction and to prevent the carbon monoxide (CO) produced from burning off into carbon dioxide (CO2). As an alternative and also cumulative possibility for cooling, it can also be provided that raw material that has already been heated, but not yet deacidified, is blown into the reactor. The heat prevailing in the reactor is absorbed by the deacidification reaction as an endothermic process, which also makes it possible to reduce the temperature of the extremely hot gases originating from the rotary furnace.

### BRIEF DESCRIPTION OF THE DRAWINGS

The invention will be explained in further detail with reference to the following FIGURE. The FIGURE is as follows:

The FIGURE shows a plant for the production of cement clinker according to the invention with a reactor configured as a gooseneck reactor.

### DETAILED DESCRIPTION OF THE PREFERRED EMBODIMENTS

The FIGURE shows a plant 1 for the production of cement clinker according to the invention in which raw meal 2 is fed into the preheater 1.1. The raw meal 2 passes through the individual cyclone preheating stages of the preheater 1.1 from top to bottom in countercurrent to the exhaust air rising in the preheater 1.1 from the calciner 3. In the calciner 3, under addition of fuel, fuel heat is generated that deacidifies the raw meal 2, i.e., in an endothermic reaction, carbon dioxide (CO2) is removed in a chemically formal manner from the lime (CaCO3) contained in the raw meal 2, so that burnt lime remains in the form of calcium oxide (CaO). When it arrives at the cyclone preheating stage 1.2, the preheated raw meal 2 is fed into the bottom of the calciner 3 via a line 1.3, where the raw meal 2 is entrained by tertiary air 4 from a clinker cooler 11 into a tertiary air line 4.1. At this point, the raw meal 2, together with the gas that otherwise flows in a countercurrent, flows into the plant 1 instead of flowing in a countercurrent. On rising together in the calciner 3, the raw meal 2 from line 1.3 and the tertiary air 4 from tertiary air line 4.1 pass the inflow site at the gas outlet 5.2 for the offgas flowing from the reactor 5 resulting from the carbonization, pyrolysis and/or combustion of poorly ignitable fuel 6, which is produced in the plant 1 shown here for the production of cement clinker CC in a gooseneck reactor. The offgas from the reactor 5 burns in the calciner 3, where it generates a considerable amount of heat that is absorbed in the endothermic deacidification reaction taking place therein. The calciner 3 shown here has a vortex chamber 7 at the end of the calciner 3 in which the burnoff gas and any fuel injected into the calciner 3 can be fully burned out before the offgas of the calciner 3 flows into the heat exchanger 1.1, because to the extent possible, no further substance conversion should take place in the heat exchanger 1.1. On passing through the lowest cyclone heat exchanger stage 1.4, the raw meal 2 is separated and fed via a line 1.5 into the rotary furnace inlet chamber 9, where the raw meal 2 is further heated for sintering in the rotary furnace 8. In order to distribute the gas flows into the calciner 3 between the tertiary air line 4.1 and the reactor path, a valve system 10 is provided by means of which the air can be divided between the tertiary air line 4.1 and the reactor 5. The poorly ignitable fuel 6 is ignited at a combustion site in the reactor 5 at which, however, because of its poor ignitability, the fuel is only slowly burned off, carbonized, or pyrolyzed in the heat of the rotary furnace offgas.

According to the concept of the invention, it is provided that there is at least one incoming air line 12 for fresh air on at least one site in the reactor 5 above the fuel 6 supply. The preheated tertiary air 4 brings a considerable amount of heat energy into the reactor 5 in order to reliably gasify or even pyrolyze the fuels therein, wherein the gasification and pyrolysis take place as an endothermic process. In addition to the gasification of fuel 6, the reduction of carbon dioxide (CO2) from the offgases of the rotary furnace 8 to carbon monoxide (CO) also takes place in a Boudouard reaction in the reactor. The decrease in temperature occurring during endothermic process control inside the reaction section of the reactor 5 on the path between the supply of fuel 6 and the fresh air feed lines 12.1 and 12.2 is compensated for by combustion that is substoichiometric with respect to the fuel and superstoichiometric with respect to the combustion air or oxygen present, with the combustion taking place as an exothermic process.

In order to prevent the gasification from “overshooting” or the reduction of carbon dioxide (CO2) in the offgases of the reactor from being on the side of the carbon dioxide rather than the side of the carbon monoxide due to excessively high temperature, it is provided to use cooling means according to a configuration of the method. The cooling can be carried out by means of raw meal feed via a raw meal feed line 1.6 and via injection of water vapor or water at this site, and optionally at further sites that require temperature regulation.

In the ideal case, the process control is carried out autothermically by regulating the fresh air supply to the fresh air inlet lines 12.1 and 12.2. In autothermic process control, by means of exothermic process steps, exactly as much combustion or process heat is produced as that consumed by endothermic process steps that also occur during the process.

In order to control the gasification and the Boudouard reaction in connection therewith taking place in the reactor 5, a fuel 6 or a difficult fuel is preferably fed in at the bottom of the reactor 5, with the fuel beginning to undergo gasification in the rotary furnace offgases from the rotary furnace 8. The decrease in temperature due to the endothermic gasification reaction before the first fresh air feed 12.1 and before the second fresh air feed 12.2 is compensated for by the fresh air feeds 12.1. and 12.2, because the carbon monoxide (CO) already produced is burned there to form carbon dioxide (CO2) in an exothermic process step. In this case, it is preferably provided that the fresh air supply at the fresh air feeds 12.1 and 12.2 is just high enough for the process in the reactor 5 to take place autothermically. Because of the autothermic process control, the gas flowing in the descending branch 5.1 of the reactor 5 has an unchanged temperature with respect to the rotary furnace offgases.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

LIST OF REFERENCE NOS.

| | |
|---|---|
| 1 | Plant |
| 1.1 | Preheater |
| 1.2 | Cyclone heat exchanger |
| | stage |
| 1.3 | Line |
| 1.4 | Cyclone heat exchanger |
| | stage |
| 1.5 | Line |
| 1.6 | Raw meal feed |
| 2 | Raw meal |
| 3 | Calciner |
| 4 | Tertiary air |
| 4.1. | Tertiary air line |
| 5 | Reactor |
| 5.1 | Descending branch |
| 5.2 | Inflow site/gas outlet |
| 6 | Fuel |
| 7 | Vortex chamber |
| 8 | Rotary furnace |
| 9 | Rotary furnace inlet chamber |
| 10 | Valve system |
| 11 | Clinker cooler |
| 12 | Inlet air line |
| 12.1 | Fresh air feed |
| 12.2 | Fresh air feed |
| CC | Cement clinker |

1-11. (canceled)

12. A plant for the production of cement clinker from raw meal comprising, seen in the direction of material flow:
at least one calciner for deacidification of the raw meal, and
at least one rotary furnace for sintering of the deacidified raw meal into cement clinker,
wherein the deacidified raw meal, after passing through the calciner, flows through a cyclone preheating stage into the rotary furnace,
wherein a reactor installed upstream of the calciner on the flow path of the offgas of the rotary furnace to the calciner is provided, to which an inlet for the offgas of the rotary furnace leads, and
wherein at least one inlet air line for the supply of fresh air is provided at at least one site in the reactor.

13. The plant as claimed in claim 12, wherein the fresh air comes from a tertiary air line that feeds recuperation air from a clinker cooler installed downstream of the rotary furnace in the direction of material flow back into the plant.

14. The plant as claimed in claim 12, wherein a control device is provided that regulates the fresh air supplied to the reactor based on at least one of the following parameters:
average reactor temperature,
reactor temperature in the lower area of the reactor,
reactor temperature in the upper area of the reactor,
NOx emissions, and
gasification rate, measured as CO concentration.

15. The plant as claimed in claim 12, wherein at least one of
a feed of water or water vapor to the reactor, or
a feed of oxygen-enriched air or pure oxygen is provided.

16. The plant as claimed in claim 12, wherein at least one feed of raw meal that is heated but has not yet flowed through the calciner to the reactor is provided.

17. A method for operating a plant for the production of cement clinker from raw meal comprising, seen in the direction of material flow:
at least one calciner for deacidification of the raw meal and
at least one rotary furnace for sintering of the deacidified raw meal into cement clinker, wherein
the deacidified raw meal, after passing through the calciner, flows through a cyclone preheating stage into the rotary furnace,
comprising the steps:
conducting the offgases of the rotary furnace to a reactor installed upstream of the calciner on the flow path of the offgases of the rotary furnace to the calciner,
adding fuel to the reactor in a superstoichiometric amount in relation to the residence time of the offgases in the reactor so that carbon dioxide contained in the offgases is reduced to carbon monoxide, and
supplying fresh air to the reactor at at least one site in the reactor.

18. The method for operating a plant for the product of cement clinker as claimed in claim 17, wherein the fresh air comes from a tertiary air line that feeds the recuperation air from a clinker cooler installed downstream of the rotary furnace in the direction of material flow back into the plant.

19. The method for operating a plant for the production of cement clinker as claimed in claim 17, wherein control of the fresh air supplied to the reactor is based on at least one of the following parameters:
average reactor temperature,
reactor temperature in the lower area of the reactor,
reactor temperature in the upper area of the reactor,
NOx emissions, and
gasification rate, measured as CO concentration.

20. The method for operating a plant for the production of cement clinker as claimed in claim 17, including a step of at least one of:
feeding at least one of water or water vapor into the reactor at at least one site, or
feeding at least one of oxygen-enriched air or pure oxygen into the reactor at at least one site.

21. The method for operating a plant for the production of cement clinker as claimed in claim 17, including the step of heating at least one feed of raw meal before it has flowed through the calciner through a feed line.

22. The method for operating a plant for the production of cement clinker as claimed in claim 17, including an autothermic process control in which the heat absorbed by the process for endothermic gasification of fuel to carbon monoxide is compensated for by the heat released by the process on combustion of carbon monoxide to carbon dioxide.
